(19) United States
(12) Patent Application Publication
(10) Pub. No.: US 2009/0263775 A1
(43) Pub. Date: Oct. 22, 2009

(54) Systems and Methods for Surgical Simulation and Training

(75) Inventor: Christopher J. Ullrich, Ventura, CA (US)

Correspondence Address: PATENT DEPARTMENT (51851);KILPATRICK STOCKTON LLP, 1001 WEST FOURTH STREET, WINSTON-SALEM, NC, 27101, US

(73) Assignee: Immersion Medical, Gaithersburg, MA (US)

(21) Appl. No.: 12/427,856

(22) Filed: Apr. 22, 2009

Related U.S. Application Data
(60) Provisional application No. 61/047,022, filed on Apr. 22, 2008.

(51) Int. Cl. G09B 23/28

(52) U.S. Cl. 434/267

(57) ABSTRACT

A surgical simulation and training platform can mimic human physiology to the extent possible, while enabling dynamic pathology and complication introduction to facilitate training and evaluation needs. The platform can include a subject body having an outer surface and defining at least one cavity, with a capture mechanism configured to receive an instrument and mounted to a robotic positioning assembly within the cavity. The system can further include one or more sensors configured to determine the position of at least one instrument or provide data for determining the position, and a processor. The processor can receive data indicating a position of at least one instrument relative to the cavity in a subject body and provide a command to the robotic positioning assembly to adjust the position of the capture mechanism to encounter and engage the instrument during surgical simulation.

### CROSS-REFERENCE TO RELATED APPLICATION AND PRIORITY CLAIM

This application claims priority to U.S. Provisional Patent Application No. 61/047,022 by Christopher J. Ullrich, filed Apr. 22, 2008 and entitled “Systems and Methods for Surgical Simulation and Training,” which is incorporated by reference herein in its entirety.

### BACKGROUND

Today, medical simulation systems exist to train physicians inexperienced in specific medical procedures or to sharpen the memory or senses of seasoned physicians. Conventional medical simulation systems may not provide an immersive feel to the physicians. As a result, a physician may need to interact with the simulation system in ways that would not occur while performing the procedure on a live subject. For example, a simulation system may require a doctor to enter settings for particular tools to be used, to change the view or perspective of the subject, or to physically interface the tool and the system before interaction by the system with the tool. In addition, conventional simulations may be unable to reflect the environment in which the physician operates.

### SUMMARY

Existing medical simulation platforms may be constrained by the physical interface that they provide to the user. In such systems, each new procedure typically requires development of a completely new robotic-haptic interface. However, some procedures, such as laparoscopy, have dynamic physical approaches that may be difficult to support with a single haptic interface. In conventional systems, the haptic interface comprises the tools and the feedback, visual and otherwise, provided to the physician

Embodiments disclosed herein can provide systems and methods for medical simulation and training. Such embodiments may include next generation robotic interfaces. Embodiments can provide a next generation surgical simulation and training platform that mimics human physiology to the extent possible, while enabling dynamic pathology and complication introduction to facilitate training and evaluation needs.

Embodiments include an apparatus comprising a capture mechanism configured to receive an instrument such as a surgical tool or object used as a tool during a simulation. The capture mechanism can be mounted to a robotic positioning assembly configured for positioning the capture mechanism within a cavity of a mannequin. The robotic positioning assembly can be configured to allow at least two degrees of freedom in adjusting the position of the capture mechanism within the cavity in some embodiments.

The positioning assembly may be part of a system for surgical simulation comprising a subject body having an outer surface and defining at least one cavity. The capture mechanism and robotic positioning assembly can be mounted within the cavity. The system can further comprise one or more sensors configured to determine the position of at least one instrument or provide data for determining the position, and a processor. The processor can receive data from the sensor indicating the position of at least one instrument relative to the cavity in the subject body and provide a command to the robotic positioning assembly to adjust the position of the capture mechanism. The surgical simulation system can thereby support simulations with arbitrary placement of ports or other interaction with the simulated patient.

A method of operating a surgical simulation system can comprise accessing position data from a sensor, the data indicating the position of an instrument relative to a surgical simulation system and accessing location data from a capture mechanism, the location data indicating a position of the capture mechanism in a cavity of a subject body. The method can include sending signals to a robotic positioning assembly to adjust the position of the capture mechanism so that the capture mechanism is positioned at or substantially at a simulated point of encounter with the subject body. The method can further comprise engaging the capture mechanism and the instrument and providing haptic feedback via an actuator included in at least one of the instrument and the capture mechanism.

In some embodiments, the method comprises providing output to generate at least one visual overlay in a field of view of a user of the surgical simulation system, such as via a head-mounted display. The visual overlay may depict at least one of an anatomical feature of a simulated patient, an appearance of a surgical tool, or a simulated medical condition of the simulated patient.

Embodiments include one or more computer readable media tangibly embodying program instructions which, when executed by a processor, cause one or more processors to perform steps comprising: determining the position of a surgical tool relative to a simulated patient, determining the location of a tool capture mechanism relative to the simulated patient, and sending signals to a robotic positioning assembly to position the tool capture mechanism at or near the point at which the surgical tool will encounter the simulated patient. The steps may further comprise sending signals to generate haptic feedback once the tool capture mechanism encounters the simulated patient.

These illustrative embodiments are mentioned not to limit or define the limits of the present subject matter, but to provide examples to aid understanding thereof. Illustrative embodiments are discussed in the Detailed Description, and further description is provided there. Advantages offered by various embodiments may be further understood by examining this specification and/or by practicing one or more embodiments of the claimed subject matter.

### BRIEF DESCRIPTION OF THE DRAWINGS

A full and enabling disclosure is set forth more particularly in the remainder of the specification. The specification makes reference to the following appended figures.

FIG. 1 illustrates an illustrative apparatus for surgical simulation.

FIG. 2 illustrates an embodiment of a robotic positioning system for a capture mechanism.

FIG. 3 illustrates another embodiment of a robotic positioning system for a capture mechanism.

FIG. 4 illustrates a further embodiment of a robotic positioning system for a capture mechanism.

FIG. 5 illustrates an illustrative system architecture for a surgical simulation apparatus in one embodiment of the present invention.

FIG. 6 is a flowchart illustrating steps in an illustrative process for surgical simulation in one embodiment of the present invention.

FIG. 7 illustrates another illustrative apparatus for surgical simulation in one embodiment of the present invention.

FIGS. 8-12 each illustrate aspects of a carriage comprising a tool capture mechanism in one embodiment of the present invention.

FIG. 13A illustrates a view of a surgical simulation system in use, while FIG. 13B illustrates the system shown in FIG. 13A as viewed from a user of the system via an augmented reality system in one embodiment of the present invention.

### DETAILED DESCRIPTION

Reference will now be made in detail to various and alternative illustrative embodiments and to the accompanying drawings. Each example is provided by way of explanation, and not as a limitation. It will be apparent to those skilled in the art that modifications and variations can be made. For instance, features illustrated or described as part of one embodiment may be used on another embodiment to yield a still further embodiment. Thus, it is intended that this disclosure includes modifications and variations as come within the scope of the appended claims and their equivalents.

Embodiments can utilize robotics to transform currently lifeless mannequins into appropriate medical training platforms that support the training needs of physicians. Such mannequins incorporate a variety of technical innovations. The mannequin may be configured to present itself as a physical cadaver or patient in an operating room (e.g., a rubber mannequin). In other embodiments, other types of patients, including, for example, stock or companion animals may be simulated. Such embodiments may be able to provide a realistic response to both open and minimally invasive surgery (“MIS”) style procedure training.

Originally, MIS was developed to reduce recovery time, decrease the need for rehabilitation, and create less disruption of tissue. MIS techniques are used in a growing number of procedures, including, for example, cardiovascular, neurological, spinal, laparoscopic, arthroscopic, and general surgery. MIS is likely to continue to expand to surgeries such as orthopedic and others.

In one embodiment, one or more haptic capture mechanisms are embedded in the peritoneum of the training simulator. These capture mechanisms may dynamically readjust their mechanical configuration to receive surgical instruments, such as laparoscopic insertion devices, and provide appropriate impedance functions to the physician. Through use of one or more positioning assemblies, a surgical simulation can accommodate arbitrary placement of ports and other insertions rather than limiting the simulation to the use of pre-defined locations for ports.

### An Illustrative System for Surgical Simulation

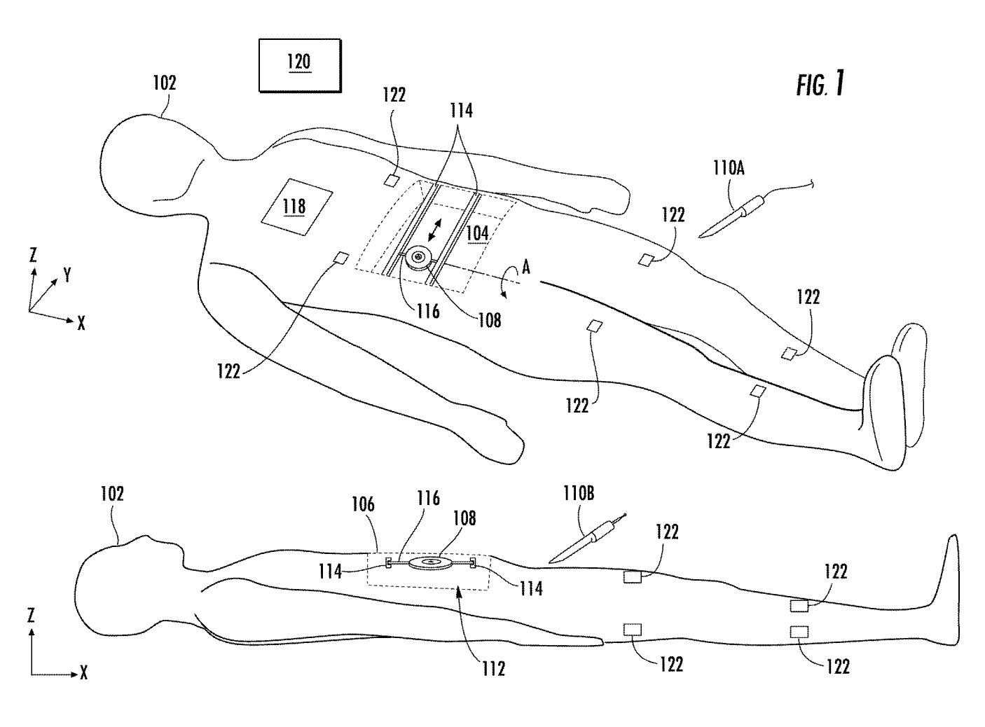

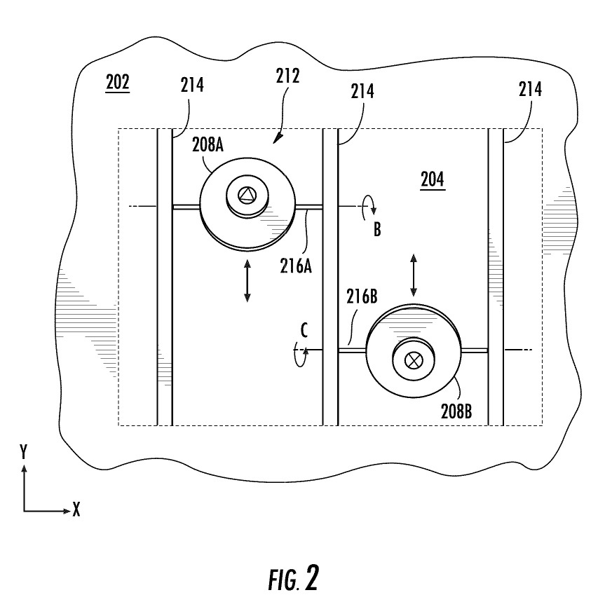

FIG. 1 illustrates an example of an apparatus for surgical simulation. In this example, the system comprises a subject body 102 having an outer surface and defining a cavity 104. Although a single cavity 104 is shown at the abdomen of body 102 in this example, a subject body may include multiple cavities. Other illustrative locations include the throat, groin, or shoulder of the body. The cavity or cavities may be configured to be reachable from the outer surface of body 102 from the top, bottom, and/or sides of body 102 as appropriate.

As can be seen in the side view of FIG. 1, a cavity may include a cover 106 corresponding to the outer surface of body 102. For example, cover 106 may comprise a rubber sheet or other suitable material to simulate skin of body 102 that is piercable by an instrument during the simulated procedure. In some embodiments, cover 106 may not be used, however, as noted later below.

The surgical simulation system comprises a capture mechanism 108 that is configured to receive one or more instruments 110A or 110B. Such capture devices may include, for example high bandwidth, multi-DOF graspers having a small work envelope. As will be noted below, an instrument 110 can comprise a fully-functional surgical tool or may comprise a proxy or “dummy” object having some aspects of a surgical tool (e.g., a similar shape in at least some respects).

The capture mechanism may be designed to interface with one or more particular instruments or may be able to dynamically reconfigure itself to capture a particular tool being used. For example, the capture mechanism may comprise a grasper through which an instrument being inserted may pass. An aperture may be defined by an iris for passage of instruments through the capture mechanism.

In some embodiments, the grasper may include a plurality of iris petals to define the iris. In order to grasp a tool, the grasper may contract the aperture by moving the iris petals. The iris petals may include a rough edge in order to apply friction to the tool when grasped. As another example, the iris petals may include a sharp edge in order to pinch the tool to be grasped. As yet another example, the petals may include actuated rollers that can provide computer-controlled resistance to the inserted tool. Additional illustrative details of the operation of capture mechanisms are also illustrated in the discussion of carriages later below.

In one embodiment, a trocar is inserted into the mannequin. A surgical trocar is used to perform laparoscopic surgery. The trocar is used as a port for laparoscopic surgery to introduce cannulas or other tools into body cavities or blood vessels. Once the trocar is inserted, the laparoscopic instruments, such as scissors, graspers etc., are inserted to perform surgery. Laparoscopic surgery allows the surgeon to avoid making a large abdominal incision, which may be referred to as open surgery. In one embodiment of the present invention, following trocar insertion, various laparoscopic tools are introduced into the trocar and automatically captured by an encounter-style haptic interface.

Encounter-style haptic interfaces are robotic mechanisms that automatically position themselves in space such that a user will feel realistic contact sensations with their hand or other handheld tool. These interfaces are typically external to the user and because of their high bandwidth are capable of extremely realistic haptic rendering. For example, a user may select a surgical tool and search for a suitable area on the simulated patient at which to insert the tool. The surgical simulator is configured to track the location and orientation of the surgical tool and position itself to receive the tool as it is inserted within the simulated patient.

One illustrative embodiment of an encounter-style interface is provided by Yokohohji, Y, Muramori, N., Sato, Y, Yoshikawa, T., Designing an Encountered-Type Haptic Display for Multiple Fingertip Contacts based on the Observation of Human Grasping Behavior, Robotics Research, Vol. 15, 2005, pp. 182-191, Springer Berlin/Heidelberg, the entirety of which is hereby incorporated by reference.

In this example, an encounter-style interface is achieved by mounting each capture mechanism 108 to a robotic positioning assembly 112 within cavity 104. In this example, the entirety of robotic positioning assembly 112 is located in cavity 104, although portions of the positioning assembly may extend outside of cavity 104 in some embodiments.

The system includes one or more sensors 120/122 that are configured to provide information regarding the position of the instrument(s) 110 and a processor configured to determine a position of the instrument(s) 110 relative to cavity 104. For example, the processor(s) may be included in a controller 118 that is linked to sensors 120/122, positioning assembly 112, and capture mechanism 108. Sensors can be used to track the instruments within and outside the simulated patient as well as the movement/position of the physician or other user of the system.

In addition to one or more processors, controller 118 may comprise, for example, a general purpose or specialized computing device interfaced with the sensors, positioning mechanisms, and other surgical simulation components via wireless or wireline links.

The processor(s) can use a triangulation or trilateration algorithm to determine the location of the instrument based on one or more signals received from the sensors, wherein each sensor signal indicates a distance from the surgical tool to the sensor. The processor(s) can then provide one or more commands to robotic positioning assembly 112 to adjust the position of capture mechanism 108.

In some embodiments, the tracking and positioning functionality is provided as part of a medical simulation application. The position (i.e. the location and/or orientation) of the instrument can be tracked and the capture mechanism positioned so that the capture mechanism is at an appropriate position orientation to capture the instrument at or substantially at a simulated point at which the instrument encounters the subject body (or would encounter the subject body if the body did not include the cavity).

For example, the point of encounter may correspond to a point at which an incision is made in a simulated surgical procedure, a point at which a tool is inserted into an existing incision, orifice, or port during the procedure, and/or a point at which another interaction with the simulated patient occurs.

“Substantially at” is meant to include cases in which the capture mechanism is not precisely located at the same point as the instrument or oriented to the same angle as the instrument, but is located/oriented close enough to the point/angle at which the instrument encounters the simulated patient to engage the instrument. For example, a capture mechanism may feature a cone structure or noose that can grab an instrument and thereby have a range of locations or orientations over which the capture mechanism can engage the instrument.

Sensor 120 may, for example, comprise an optical sensor that can be used to track the position of an instrument 110 using visual analysis techniques. Additionally or alternatively, sensors 122 may comprise magnetic, optical, or other sensors that can be used to triangulate the position of instrument 110. Sensors 122 may be positioned on or in subject body 122, on or near a table or other surface supporting subject body 122, on or near capture mechanism(s) 108, on instrument 110, and/or at any other suitable location.

In some embodiments, instrument 110 comprises a transmitter for use in locating its position. In some embodiments, various sensor methods commonly used in touch screens may be utilized, such as electromagnetic, resistive or capacitive, surface acoustic wave, optical imaging, dispersive signal, or acoustic pulse recognition technology. For example, control unit 118 may determine when an instrument has reached the outer surface of subject 102 by determining when the “skin” has been touched or when an instrument is near the outer surface of the simulated patient and then adjust the location and/or orientation of one or more capture mechanisms 108 appropriately.

In this example, robotic positioning assembly 112 comprises a gantry mechanism, namely a carriage configured to engage and move along a pair of tracks 114 supporting a gimbal 116 to which capture mechanism 108 is mounted. As instrument 110 is moved along the Y axis, gimbal 116 can be repositioned along tracks 114 to follow the instrument. Additionally or alternatively, the approach angle of instrument 110 can be determined from sensor data and capture mechanism 108 can be rotated about one or more axes so that instrument 110 can be received by capture mechanism 108 at the angle of approach. For instance, instrument 110 may approach the side of subject body 102. Positioning assembly 112 can be moved in the +y or −y direction as appropriate and capture mechanism 108 can be rotated in the +A or −A direction to match the angle of instrument 110.

In this example, a single capture mechanism 108 is depicted. However, in some embodiments, multiple capture mechanisms can be provided. As an example, multiple gantry mechanisms could be layered in the z-direction to allow for simulation of multiple ports simultaneously. A first capture mechanism 108 may interact with a trocar while a second mechanism layered below the first capture mechanism may interact with tools inserted via the trocar, for instance.

In any event, the processor can be configured to adjust the position of capture mechanism(s) 108 so that when instrument 110 approaches the outer surface of the subject body at a border of the cavity (corresponding to cover 106 in this example), capture mechanism 108 is positioned to capture the instrument as the instrument passes the outer surface of the subject body. Put another way, capture mechanism 108 is placed into a position so that, as the instrument enters cavity 104, capture mechanism 108 can engage the instrument and the surgical simulation system can begin to provide suitable feedback to a user of the instrument to simulate the surgical procedure.

For example, the processor may be configured so that, once one or more instruments are engaged in respective capture mechanisms 108, the processor provides one or more haptic feedback signals to an actuator (or actuators) to generate haptic feedback with regard to the instrument(s). In some embodiments, some of the haptic feedback is provided before engagement to simulate other aspects of the procedure—for example, if a proxy for a tool is used, one or more suitable mechanisms may be used to simulate the behavior and “feel” of the tool outside of a body.

The haptic feedback can be generated via an actuator in at least one of the instrument, the capture mechanism, or a wearable peripheral device in response to the signals provided by the processor. For example, as noted below, a wearable peripheral such as a glove can be used to simulate tension, resistance, and other forces that may be encountered when using a surgical tool; this may facilitate use of proxy instruments rather than functional surgical tools, although such feedback could be used to enhance the experience when functional surgical tools are used in the simulation.

Feedback may be provided via the instrument, either alone or in combination with the capture mechanism. For example, proxy instruments or actual instruments specifically configured for simulation may be used such as instruments 110A and 110B shown in FIG. 1. Instrument 110A includes a wire link to controller 118, while instrument 110B illustrates a wireless link provided by a transmitter included in or on instrument 110B. The links may be used to transfer data to and from the instrument while in use. For example, controller 118 may send signals for the instrument to generate haptic feedback via the wireless or wireline link.

Additionally or alternatively, the wireless or wireline link may be used to transfer positioning data generated by the instrument (e.g., via a positioning sensor, gyroscope, etc.) for use in tracking the instrument's position. As a further example, a transmitted signal itself may be received by controller 118 and used to determine the position of the instrument even if no actual positioning data is generated onboard the instrument.

In one embodiment, a system may include a haptically-enabled surgical tool that tool provides haptic effects to a user. For example, the user may insert a haptically-enabled laparoscopic tool into the simulated patient. Capture device 108 may provide haptic effects to the user, of course, such as by providing resistance to the movement of the laparoscopic tool. However, the laparoscopic tool also provides additional haptic effects. For example, the laparoscopic tool may provide scissor grips to allow the user to open and close a claw or other grasping implement at the other end of the laparoscopic tool. If the user attempts to grasp an object within the simulated patient, the laparoscopic tool may provide resistance to the opening or closing of the scissor's grips, such as to simulate contact with an object within the patient, thus providing haptic effects in a degree of freedom different from the haptic effects provided by the capture device. In one such embodiment, advanced robotic control may be utilized to provide dynamic impedance and configuration.

A capture mechanism 108 alone may be used to provide haptic feedback. For example, some embodiments of capture mechanisms may allow for haptic feedback to be provided without the need for instruments specially configured for use in simulation—instead, functional surgical tools can be used.

Returning to the laparoscopic surgery example, a user may insert a trocar through the mannequin's “skin” where it encounters the capture device. The capture device engages with the trocar and provides resistance to movement of the trocar within the mannequin. For example, the user may attempt to insert the trocar deeply into the mannequin. The capture device may provide varying resistances as the trocar is maneuvered more deeply into the mannequin. The varying resistances to insertion or retraction of the tool, as well as to any lateral movements, may provide the user with a realistic sensation of moving the trocar within a real human body, including encountering internal organs or other tissue.

Several examples of robotic positioning assemblies are discussed herein. Generally, the system can utilize one or more robotic assemblies configured to allow at least two degrees of freedom in adjusting the position of the capture mechanism. Some embodiments may allow three degrees of freedom in adjusting the position of the capture mechanism.

The subject body may depict any suitable subject. For instance, in this example, the subject body comprises a human mannequin that has the shape and features of a human cadaver or living patient. The detail of the subject body can vary—for instance, the outer surface may include anatomical or other features (e.g., simulated skin, hair, facial features, etc.) to provide a more realistic simulation experience. However, as noted later below, the appearance of the subject body and simulated surgical experience may be enhanced through other means as well.

### Examples of Components of Surgical Simulation Systems

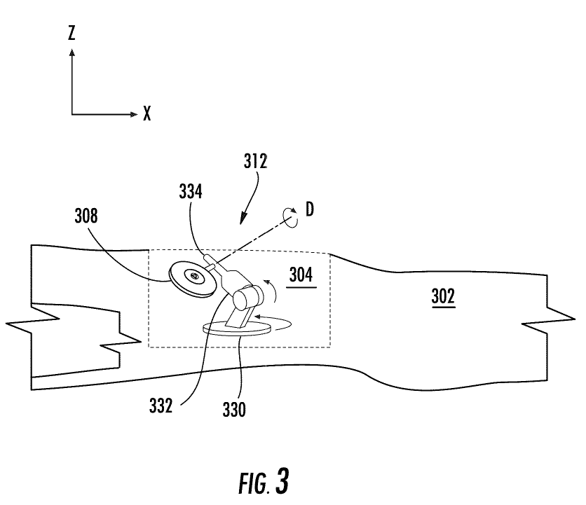

FIG. 2 illustrates an embodiment 212 of a robotic positioning assembly for a capture mechanism. In this example, the assembly supports a plurality of capture mechanisms 208A, 208B positioned using respective carriages 216A, 216B, engaged in tracks 214 within a cavity 204 of a subject body 202. Carriages 216 can move along the Y axis and rotated in directions B and C (about the x-axis) as shown. In some embodiments, carriages 216 can comprise appropriately-configured gimbals to allow rotation about the z and/or about the y axis. In some embodiments, positioning system 212 may include suitable components such as hydraulic lifts (not shown) to allow tracks 214 to be adjusted in the z direction to lift and/or lower capture mechanisms 208A/208B together or independently from one another.

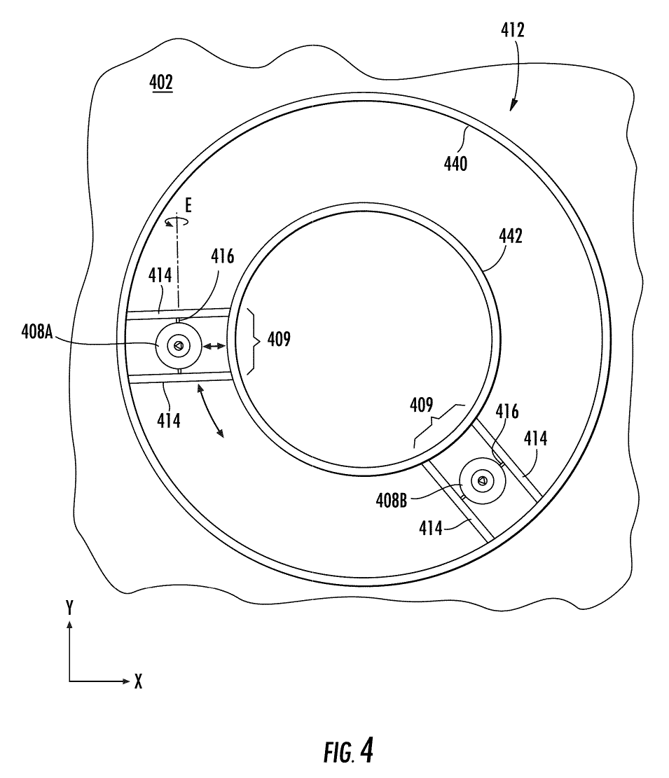

FIG. 3 illustrates an embodiment 312 of a robotic positioning assembly positioned in a cavity 304 that opens to the top and side of a subject body 302. In this example, the robotic positioning assembly comprises an articulated robot arm including a rotatable base 330 that rotates about the z axis, a first segment 312 that rotates about the y axis, and third segment 334 that facilitates rotation about the x-axis. Additionally, capture mechanism 308 may be mounted to a gimbal that allows adjustment by rotation in the +D or −D direction to allow for fine-tuning of position. The illustrative robotic arm is shown to illustrate how any suitable robotic technology can be used to allow positioning of capture mechanisms relative to a subject body.

FIG. 4 illustrates an embodiment 412 of a robotic positioning assembly within a cavity 404 of a subject body 402. In this example, tracks 440 and 442 comprise an annulus in which subassemblies 409 can rotate. Each subassembly 409 comprises a plurality of tracks 414 engaging a gimbal 416 that allows rotation of a capture mechanism 408A, 408B about one or more axes.

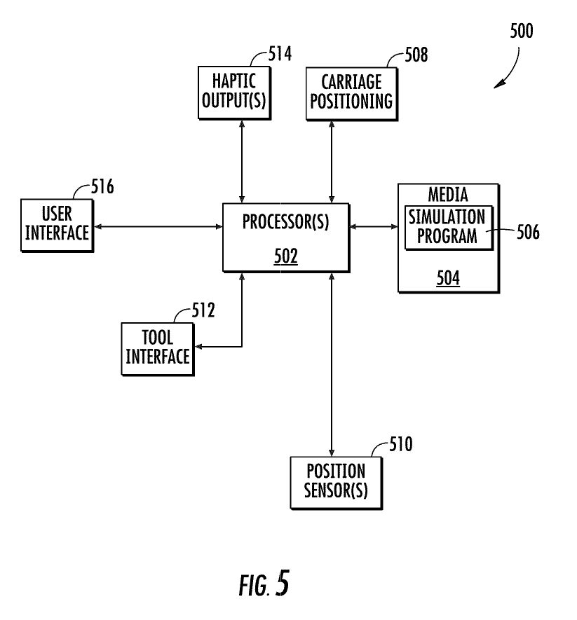

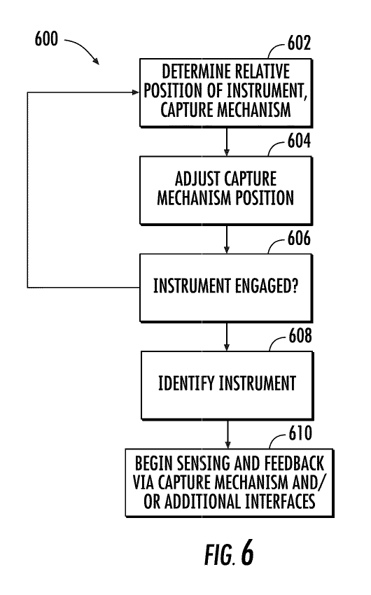

FIG. 5 illustrates an illustrative system architecture 500 for a surgical simulation apparatus in one embodiment of the present invention. For example, one or more processors 502 may access a simulation program 506 and/or other suitable software embodied in a computer-readable medium or media 506, such as a system memory. The simulation program can be used to generate appropriate haptic and other output over the course of the simulation.

Based on the accessed program instructions, processor(s) 502 can evaluate information about the current position of capture mechanisms and instruments and provide suitable commands to carriage positioning component 508, which may provide suitable commands to motors, pulleys, actuators, and other mechanisms used to adjust the position of the capture mechanism. For instance, processor(s) 502 may be directed to read data from position sensor(s) 510 and triangulate the position of one or more instruments to determine if appropriate capture mechanisms are ready to receive the instrument(s).

Processor(s) 502 are also interfaced with instrument interface 512, haptic output component(s) 514, and user interface 516. Instrument interface 512 may comprise a suitable hardware component to send data to and receive data from instruments specifically configured to support use with the simulation system. For example, as was noted above, an instrument may include an onboard position sensor or other components that can provide data to the simulation system for use in determining instrument position and/or status.

Haptic output components 514 may comprise hardware for relaying commands to capture mechanisms, haptically-enabled instruments, user peripherals, and other system components to provide haptic output during the surgical simulation. Visual, audio, olfactory, and other output components can be linked to processor 502 to receive suitable commands during the course of the simulation as well

A simulation system may incorporate one or more visual displays in communication with the processor. For instance, some embodiments described herein incorporate an augmented reality system. Other embodiments may incorporate conventional visual displays and user interfaces to provide additional information to the physician, to allow a trainer to control the parameters of a simulation, to allow configuration of the simulation or training system, or to perform other activities.

User interface 516 may comprise a keyboard, mouse, and/or other input devices along with one or more suitable display devices and can be used to configure and control the surgical simulation system For instance, in one embodiment, the trainer may use the display device and a trainer's interface to set up a training simulation meant to reflect a particular physiological condition. The physician is then able to analyze the condition using the various other elements in the system.

As another example, memory 504 may include program code for generating a selection and configuration screen whereby a user can select a particular surgical simulation, configure desired instrument and/or subject responses, and the like. The control program may also allow a user to monitor system status and select responses during the course of a simulation. As noted below, in some embodiments, one or more display devices may be used during the simulation by presenting data to the user(s) engaged in the simulation.

### An Illustrative Process for Surgical Simulation

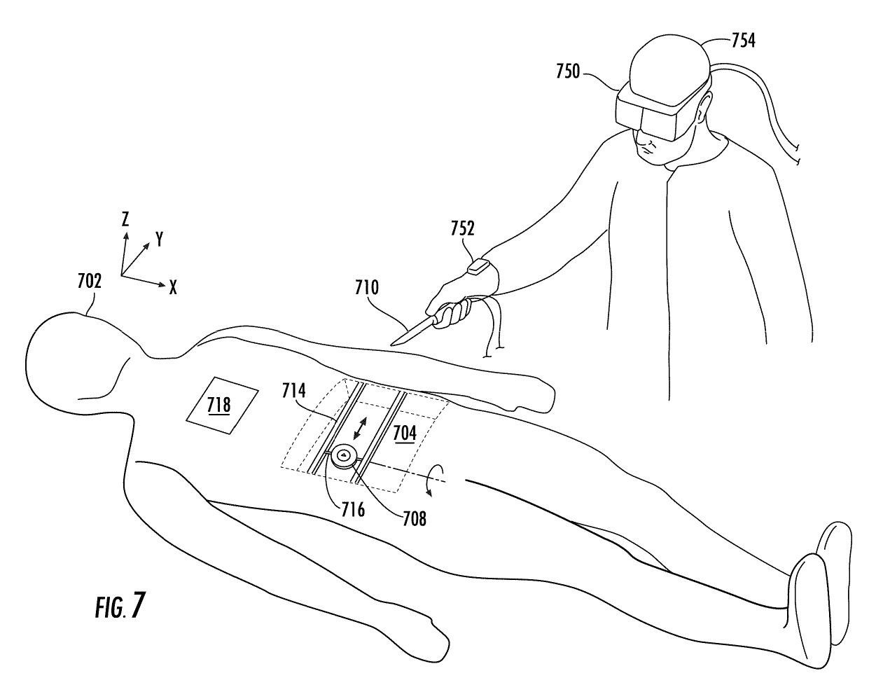

FIG. 6 is a flowchart illustrating steps in an illustrative process 600 for surgical simulation in one embodiment of the present invention. For example, process 600 may be implemented via appropriate program code accessed by the processor(s) of the surgical simulation system. At block 602, the system determines the position of one or more instruments relative to one or more capture mechanisms and/or the simulated patient. For instance, as was noted above, one or more sensors and/or data from the instrument(s) may be used to triangulate or otherwise obtain a location and/or orientation. Position data for the capture mechanism(s) can be provided from the same or different sensors—for example, the robotic positioning assembly or assemblies may include encoders or other suitable components to provide data on the current location/orientation of capture mechanisms.

At block 604, the position of one or more capture mechanisms are adjusted as needed. For example, a suitable capture mechanism may be moved into a position to be ready to engage an instrument when the instrument encounters the simulated patient. As another example, the capture mechanism may be rotated to present a suitable orientation for receiving the instrument.

In some embodiments, block 604 further comprises configuring the capture mechanism to receive the instrument. For example, if a capture mechanism supports engagement with a plurality of different instruments, the instrument(s) in use during the surgical simulation may be identified and the capture mechanism(s) may be configured for ready acceptance of the instruments in use. As another example, if specific capture mechanisms are used for respective instruments, then the appropriate capture mechanism can be positioned to receive their respective instruments.

At block 606, the system determines if the instrument has engaged the capture mechanism. In this example, the system loops to block 602 to continue tracking the capture mechanism and instrument positions and adjusting the capture mechanism appropriately. Once the instrument is engaged with a capture mechanism, the instrument is identified at block 608 (if not identified previously) and at block 610 sensing and haptic feedback begins via the capture mechanism and/or additional interfaces supported by the processor. For example, as was noted above, the instrument itself may be configured to provide haptic feedback and/or one or more wearable peripherals may be used to provide feedback during the course of the simulation.

For example, in one embodiment, an autocapture device captures the instrument that is inserted by the physician and provides realistic haptic feedback to the physician based on the clinical problem that the physician is addressing. The feedback may be adjusted during the course of the simulation in order to simulate the effects of changes in a patient's condition during surgery and/or to simulate different pathologies.

In some embodiments, aspects of process 600 occur throughout the simulation. For example, while haptic feedback is provided via a first capture mechanism, the position of a second instrument may be tracked and a corresponding second capture mechanism may be adjusted accordingly. Thus, the system can support simulation of surgical procedures involving multiple instruments. Although FIG. 6 refers to adjusting the capture mechanism position, additional components may be adjusted. For example, tracks or other portions of the robotic positioning assembly may be retracted or moved to facilitate repositioning of capture mechanisms. Haptic feedback may be provided throughout the simulation and not only after engagement between the capture mechanism and tool.

### An Illustration of a Surgical Simulation Utilizing an Augmented Reality System

FIG. 7 illustrates another illustrative apparatus for surgical simulation in one embodiment of the present invention. In this example, a subject body 702 comprises at least one cavity 704. A positioning mechanism comprising rails 714 and gimbal 716 is used to adjust the location/orientation of a capture mechanism 708. In this example, an augmented reality interface is utilized in the surgical simulation.

Advanced augmented reality technologies further enhance the realism of the robotic training system. Further, such technologies provide a high degree of freedom (“DOF”) for the training physician. For example, in one embodiment, visual overlay display of the operative surrounding, other participants, and the patient physiology/anatomy make the learning/analysis experience very similar to a real scenario.

In another embodiment, direct haptic display on the user's hands enables simulation of a wide variety of surgical tools, eliminating the need for a large physical collection of surgical instruments and medical tools. In this example, a surgical simulation system user 754 utilizes an instrument 710. For example, instrument 710 may comprise a proxy for an actual instrument, and may comprise a simple rod or other structure having the basic physical shape of a surgical tool but no surgical functionality. Instead, the appearance of various tools may be provided via the augmented reality aspects.

In yet another environment, auditory and olfactory feedback is utilized to round out the simulation experience. In an advanced augmented reality system, a simulation, such as a computer application, may cause a variety of effects to be generated. These effects help to augment a user's perception of reality. A computer, or processor, may be in communication with the advanced augmented reality system, and be configured to generate various effects. A processor, for example, may generate graphical effects, auditory effects, or olfactory effects and haptic effects. One or more of these effects may be interleaved into a live simulation to enhance the user's experience.

In one embodiment, an advanced augmented reality system comprises a visual overlay system. The visual overlay system, for example, may comprise a head-mounted display 754. The head-mounted display can include a pair of display optics: a left display optic corresponding to a left eye, and a right display optic corresponding to a right eye. In another variation, the head-mounted display may comprise a single display optic. The display optic may comprise a CRT display, a Liquid Crystal Display (LCD), a Light Emitting Diode Display (LED), or some other display device.

The advanced augmented reality system may be configured to register the external environment, or surroundings, and output the surroundings to a user. For example, one or more cameras may be in communication with a visual overlay system. During a simulation, the visual overlay system may generate a display of the operative surroundings based on the images or video captured by the camera(s). As one example, two cameras are mounted on a head-mounted display. Each camera is configured to provide video for display by the head-mounted display. The cameras may also provide a video feed to other sources, such as a video recorder, or a remote display. By providing multiple video feeds during a simulation, a simulated procedure may be recorded for later playback, broadcast for immediate feedback, or used by a simulation supervisor to modify the simulation as it progresses.

The visual overlay system may be configured to simulate a three dimensional reality. In one variation, a pair of cameras each provides an image to a visual overlay system. The images may be presented to give the illusion of depth, or three dimensions, for example, as a stereoscopic image displayed by the visual overlay system.

A computer, or a processor, may be in communication with the head-mounted display, and configured to generate various effects, such as visual effects. For example, the computer/processor may be the same processor of controller 718 that handles tracking of instruments and positioning capture mechanisms or may comprise a separate system that interfaces with controller 718.

The visual effects may be displayed on the visual overlay system. Various effects may be combined with a live video feed to provide an augmented reality experience. A graphical effect, such as an icon (e.g. an arrow, line, circle, box, blinking light or other indicator) may be visually overlaid on a display feed. By overlaying one or more effects during a simulation, the augmented reality system may provide interactive guidance. In another embodiment, various colors are overlaid on a mannequin to simulate a medical condition. For example, contusions or various skin colors indicative of particular medical conditions may be overlaid virtually on the mannequin for analysis by the physician. In one embodiment, the augmented reality system displays the abdomen laid open as the physician performs a simulated surgery. In another embodiment, the visual overly also simulates the endoscopic camera view and display monitor.

The processor may be configured to generate other types of effects, such as an auditory or sound effect, or an olfactory or scent effect. One or more effects may be output by an augmented reality system, such as by a speaker or scent generator. The augmented reality system may be in communication with other sensors. In one variation, a tactile sensor may be configured to detect the movement of a medical device. As the sensor detects movement of the medical device, the sensor may generate signals transmitted to a processor or other device. Other sensors may include fluid sensors, pressure sensors, or other sensor types.

The processor may interpret various signals, and generate one or more effects based at least in part on the signals. As one example, a sensor may be configured to track the movement of laparoscopic tool. When the processor determines that the laparoscopic tool has been over-extended, the processor may generate a signal configured to cause the augmented reality system to generate a haptic effect, such as a vibration.

In one embodiment, primitive tools, e.g. sticks with balls, may be substituted for actual instruments. In such an embodiment, the augmented reality system provides a visual overlay to make the primitive tools appear to be actual surgical instruments. Such an embodiment provides cost savings over purchasing actual instruments or simulated instruments designed to closely mirror the actual instrument. As noted above, in the illustration of FIG. 7, the instrument 710 in use comprises a simple proxy rather than an actual surgical tool.

In this example, haptic feedback can be provided when instrument 710 engages capture mechanism 708. However, additional haptic feedback can be provided during the simulation via a wearable peripheral device 752, which in this example comprises a glove. The processor(s) of control unit 718 can provide signals to a glove worn by the physician or other user.

One embodiment comprises an interface that can be grasped and made to feel like various surgical apparatus. Various systems and methods may be implemented to provide such a device. In one embodiment, the interface comprises an encounter interface. Such an embodiment would amount to a shape changing surface display. In one embodiment, the user interface device comprises a user grasp feedback device, such as the CYBERGRASP system marketed by CyberGlove Systems of San Jose, Calif. Such a device is able to provide force feedback to a user's fingers and hands, allowing the user to feel computer-generated or tele-manipulated objects as if they were real. In such an embodiment, the physician could be provided feedback for a virtual instrument or virtual part of the simulated patient's anatomy.

A robotic-augmented reality simulation infrastructure would have enormous value in the training of residents and surgeons through controlled case presentation. The system could also enable the development of novel surgical techniques and tools without risk to patients.

While embodiments have been described in terms of mimicking a human patient, other embodiments could mimic other types of animals, including, for example, dogs or cats. A subject body may be “complete” or may comprise only a portion of a body (e.g., only an abdominal portion of a human).

As mentioned above, regardless of the form of the subject body, multiple cavities may be defined. For instance, in some embodiments, a cavity is included in the head/neck region and/or extremities (e.g., arms, legs), chest, and/or back in addition to or instead of in the abdominal area of the subject body. Multiple different positioning mechanisms can be used alongside one another.

Although certain illustrative surgical tools and procedures were discussed above, it will be understood that the present subject matter can be configured for use with any desired surgical tool though use of an appropriate tool capture mechanism and/or other haptic feedback components. The present subject matter is not meant to be limited to the particular surgical procedures discussed herein for purposes of example.

### Illustrative Carriage-Mounted Capture Mechanisms

Next, additional examples of capture devices and positioning assemblies comprising carriages that engage rails are discussed. A carriage may be configured to engage with and move along a track or other guide system. However, it should be noted that the present subject matter includes any suitable positioning assembly/mechanism and is not limited to the use of rail-mounted carriages. In the figures below, a generic “i-j-k” axis is used in place of “x-y-z” so as not to imply a particular required orientation of the tracks of the following illustrative carriage configurations.

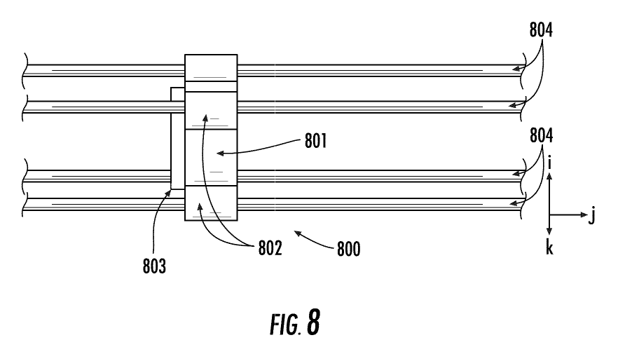

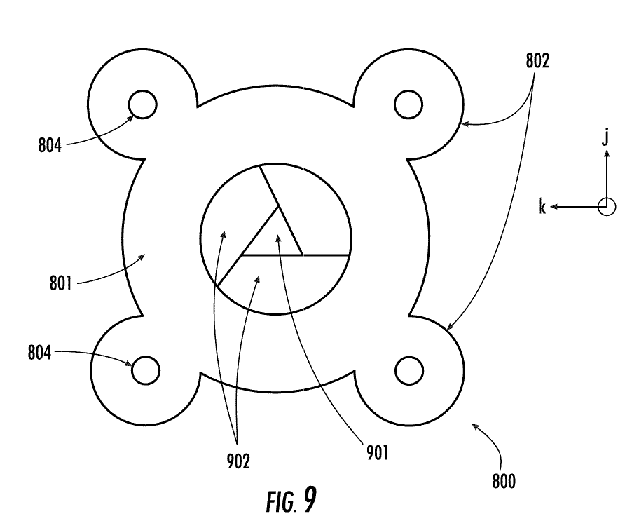

FIG. 8 is a side view of an example carriage 800 for use in one embodiment of the present invention. In this example, the carriage may include a grasper 801 for grasping a tool, at least one guide 802, and a sensor 803. Rails 804 provide a track along which the carriage 800 is configured to move in the embodiment shown. As illustrated, the rails 804 may be on four sides of the carriage 800. The guides 802 couple the carriage 800 to the rails 804 and guide carriage 800 along the rails. In one embodiment, the rails 804 may be fixedly coupled to the carriage such that the carriage cannot move with respect to the rails, but can be moved and oriented by the movement of one or more rails 804.

While the embodiment shown in FIG. 8 comprises four rails 804, some embodiments may comprise fewer rails or a greater number of rails. For example, an embodiment may comprise two rails, while another embodiment of the present invention may comprise 6 rails. Still further, the carriage may engage the rails at different points or the carriage may be oriented at a different axis relative to the axis of the rails.

In one embodiment, the sensor 803 is configured to sense and identify a tool inserted through the carriage 800. As illustrated, the sensor 803 is positioned on the distal end of the grasper 801. Therefore, a tool being inserted may pass through the grasper 801 before passing through the sensor 803. Hence, upon the sensor 803 identifying the tool, the grasper 801 is able to grasp the tool since the tool is through both the sensor 803 and grasper 801.

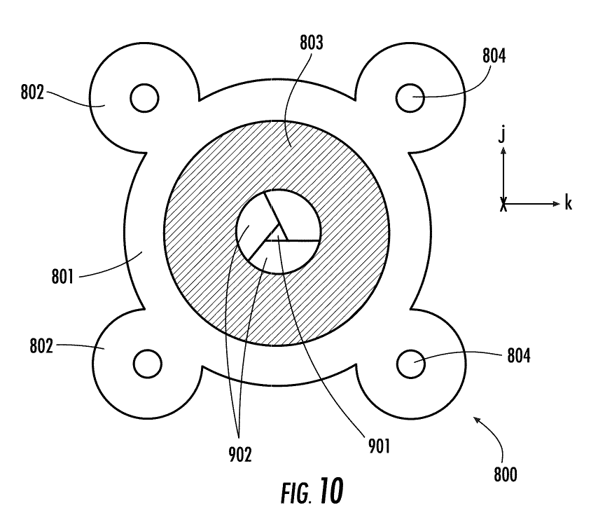

FIG. 9 is a front view (proximal side) of carriage 800 of FIG. 8. The view is of the proximal end of the grasper 801. In one embodiment, the carriage 800 may include an aperture 901 defined by an iris for passage of tools through the carriage. In one embodiment, the grasper 801 may include a plurality of iris petals 902 to define the iris. In order to grasp a tool, the grasper may contract the aperture 901 by moving the iris petals 902. Hence, a tool may be contacted by the grasper at a number of positions equal to the number of iris petals 902. In one embodiment, the iris petals include a rough edge in order to apply friction to the tool when grasped. In another embodiment, the iris petals may include a sharp edge in order to pinch the tool to be grasped. The concentric tools not grasped by the iris petals 902 (e.g., because they are inside the grasped tool) may freely move through the aperture 901 to one or more carriages 800 positioned on the distal end of the illustrated carriage 800.

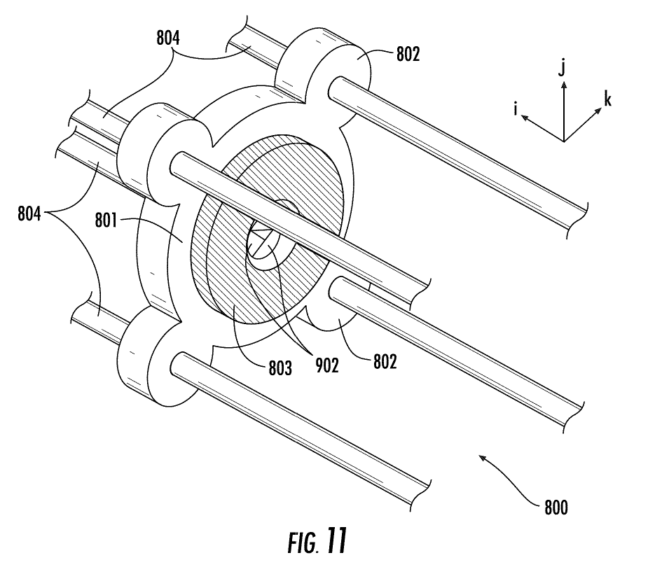

FIG. 10 is a rear view (distal side) of the example carriage 800 of FIG. 8. The view is of the distal end of the sensor 803 and the grasper 801. As illustrated, the aperture 901 and iris petals 902 are visible through the sensor 803. FIG. 11 is a top-right-rear view of the example carriage 800 in FIG. 8 in order to provide understanding of the orientation of the various portions of the carriage 800.

In one embodiment, a plurality of carriages 800 may be employed. The plurality of carriages 800 may be configured to accept different size tools. For example, carriages 800 further away from an opening in a simulated patient may be configured to accept and grasp smaller tools than carriages 800 closer to the opening. As a result, the maximum aperture size of the aperture 901 may become smaller as a tool passes through carriages 800 during insertion. This would be appropriate, for example, when using laparoscopic tools with working channels that allow surgeons to insert catheters or other secondary tools through a small channel in the main tool.

Further descriptions of carriages and their associated components may found in co-pending U.S. patent application Ser. No. 11/941,401 entitled “Systems and Methods for Medical Tool Auto-Capture”, filed Nov. 16, 2007, the entirety of which is hereby incorporated by reference.

In one embodiment, a carriage 800 may be configured to move within a simulated patient prior to the insertion of a surgical tool. For example, in one embodiment, a track may be disposed within the simulated patient to allow two degrees of translatory freedom such that the capture device can move in a plane substantially parallel with the operating surface. In such an embodiment, rails 804 may provide a third degree of freedom to allow one or more carriages 800 to move in a direction substantially perpendicular to the plane of the operating surface. In one embodiment, the rails 804 may be configured to move in the third degree of freedom. For example, the rails 804 may be coupled to the track via one or more actuators to allow the rails to be extended from or retracted towards the plane of the operating surface.

In one embodiment, each of the rails may be retracted independently of the other rails. Such an embodiment may be advantageous to allow one or more carriages to be oriented in a plane substantially parallel with the surface of the simulated patient. For example, if the simulated patient is lying on its back, a user may desire to insert a surgical tool into the patient's side (i.e. in a plane that is not parallel to the plane of the operating table). In such a case, it may be necessary to retract one or more of the rails to prevent the rail from contacting the simulated patient, or to orient a carriage 800 towards the patient's side.

In one embodiment, one or more carriages 800 may be rotatably coupled to the rails 804 to allow the carriage to rotate to orient itself in a position to receive a surgical tool inserted into the simulated patient. For example, in one embodiment, a user may desire to insert a surgical tool into the patient's side. In such an embodiment, the carriage may be configured to be rotated to receive the surgical instrument. In another embodiment, the capture mechanism may be mounted on a gimbal that permits orientation in two degrees of freedom.

As discussed above, the carriage 800 may further be configured to move with a surgical instrument in order to be positioned at the location of a surgical tool. In some embodiments, the carriage 800 may be moved such that it is not located precisely at the insertion point. Alternatively, a user may not insert the surgical tool properly. Thus, in order to more easily capture a surgical tool, in one embodiment a carriage 800 may comprise a wide aperture, or a funnel-shape to guide a surgical tool into the carriage's aperture 901. In one embodiment, the carriage 800 may comprise a loop of material, such as a cable, that may be configured to close and pull the carriage's aperture 901 into alignment with a surgical tool.

In order to track the location of the surgical tool, a carriage 800 or a surgical tool, or both, may comprise one or more sensors. For example, in one embodiment, a carriage 800 may comprise four sensors, located around the edges of its front face, separated by approximately 90 degrees. Each sensor may be configured to determine a distance to a surgical tool based on a signal received from the surgical tool. In such an embodiment, a processor in communication with the sensors may be able to determine an approximate location of the tool by analyzing the distances from each sensor to the tool, and may be configured to cause the carriage 100 to move in the direction of the surgical tool.

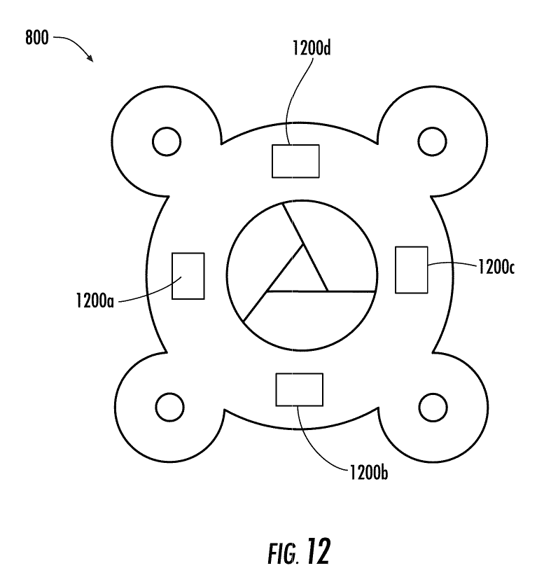

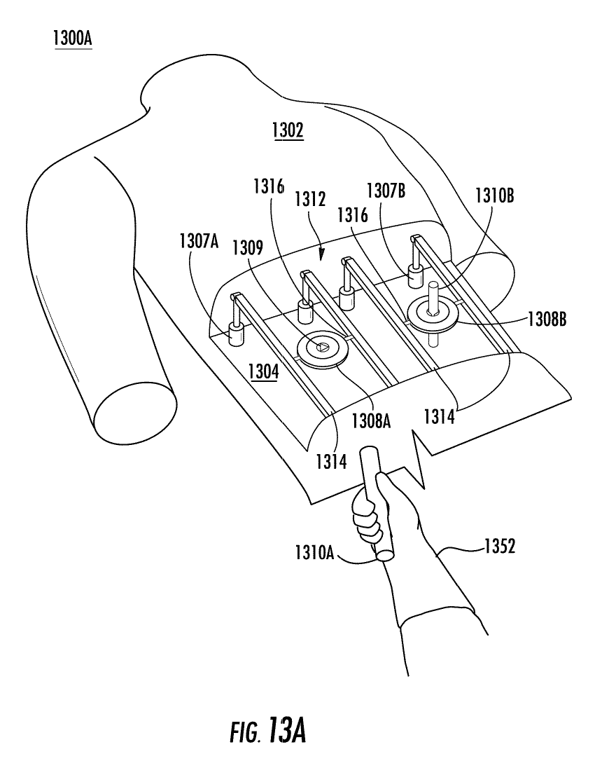

For example, FIG. 12 shows a carriage 800 having 4 sensors 1200a-d positioned on the front face of the carriage 800. The sensors may be configured to determine the distance to a surgical tool. A processor in communication with the carriage 800 may be configured to use triangulation or other techniques as noted above.

### Illustrative User Views of a Surgical Simulation

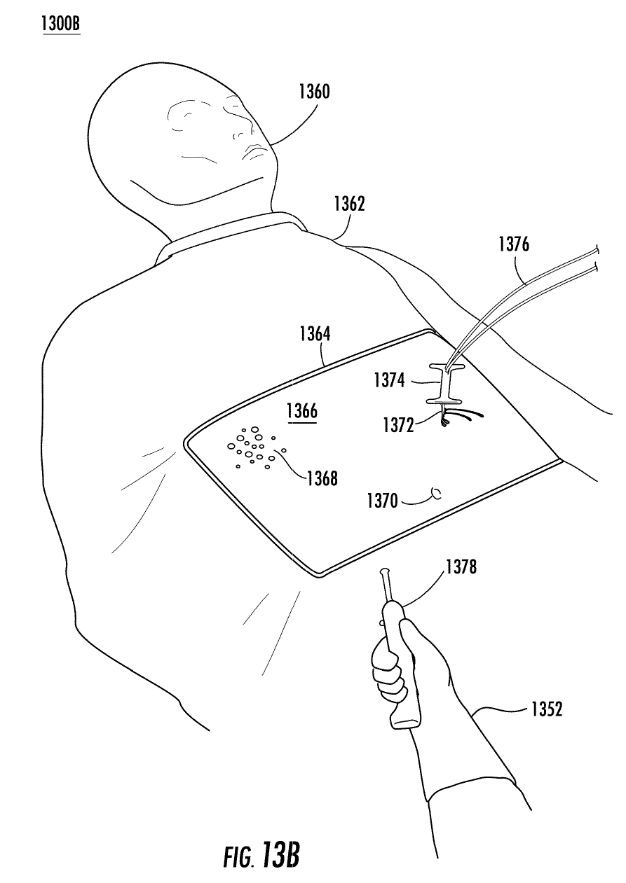

As was mentioned above, an augmented reality system may be used to further enhance a surgical simulation. FIG. 13A illustrates a view 1300A of a surgical simulation system in use from a user's point of view, while FIG. 13B illustrates a second view 1300B of the same simulation as viewed by the user via an augmented reality system in one embodiment of the present invention.

In view 1300A, subject body 1302 comprises a mannequin torso featuring a cavity 1304 opening at the top and left side. Furthermore, several components of robotic positioning assembly 1312 are visible—for instance, subject body 1302 does not include a rubber sheet or other skin simulation. Disposed within cavity 1304 are two capture mechanisms 1308A and 1308B, each featuring an aperture 1309 in a gripper that is mounted in a gimbal 1316. Each gimbal 1316 moves along tracks 1314. In this example, actuators 1307A and 1370B are visible for adjusting the tracks 1304 in the z-direction.

The user's hand 1352 is visible grasping an instrument 1310A. In this example, instrument 1310A comprises a simple rod acting as a proxy for a functional surgical tool. A second instrument 1310B is also illustrated as engaged in the aperture of 1308B—for instance, the user or another simulation participant may have already performed a procedure simulated by inserting a tool simulated via instrument 1310B.

View 1300B represents the same view as provided by an augmented reality system. Particularly, the processor(s) of the simulator system have added overlays depicting several visual features. Subject body 1302 now includes a head 1360 with facial features and the body is draped in a surgical gown 1362 with an opening 1364.

An overlay has been generated to depict anatomical and pathological features visible through gown opening 1364. Particularly, the simulated patient's skin 1366 is visible, along with a pathological or other variance 1368 and navel 1370.

Additional visual overlays have been added to simulate the previously-placed instrument. Particularly, an incision with bleeding 1372 is depicted at the point at which instrument 1310B is positioned. Instrument 1310B has itself been replaced by a visual depiction of a surgical tool 1374 with an associated line or fiber optic cable 1376. As an example, an incision may have been generated when surgical tool 1374 was initially placed and, in response from a command from a physician supervising the simulation, bleeding may have been simulated to test the response of the user(s) of the simulation

An additional overlay has been used to depict a surgical tool 1378 in the user's hand 1352 rather than the appearance of instrument 1310A. If the user is wearing a glove that provides haptic feedback, the appearance of the glove may be replaced in view 1300B with the appearance of a standard surgical glove or the surgeon's bare hand as appropriate. Other aspects of the surgical environment may be added, such as a depiction of an operating room table and the like.

Overlays may be generated in any particular manner. For example, one or more computer-readable media accessible by a processor of the simulation system can access defining the desired appearance of anatomical features, surgical environmental features (e.g., an operating room environment), tool features/appearances, and the like. One or more sensors can be used to determine the field of view of the user(s) of the simulation system and determine the appropriate location and orientation of the visual overlay or overlays to be added.

Other display devices in addition to or instead of the head-mounted display can be used. For example, for operations such as endoscopy, a simulated internal view of the patient can be generated during the procedure and presented via a physically present display device and/or via a display device or area of the head-mounted display.

As noted above, some embodiments comprise an integrated advanced simulation system. The system includes a mannequin that approximates a human patient's appearance. The mannequin in one such embodiment includes a processor or other controller. The processor may also receive sensor signals from various portions of the mannequin and from external devices such as sensors configured to sense the movement and operation of simulated tools within or outside the mannequin or to sensors configured to detect the movement of the physician.

### General Considerations

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Embodiments in accordance with aspects of the present subject matter can be implemented in digital electronic circuitry, or in computer hardware, firmware, software, or in combinations of them. In one embodiment, a computer may comprise a processor or processors. The processor comprises or has access to a computer-readable medium, such as a random access memory (RAM) coupled to the processor. The processor executes computer-executable program instructions stored in memory, such as executing one or more computer programs for editing an image. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example tangible computer-readable media, that may store instructions that, when executed by the processor, can cause the processor to perform the steps described herein as carried out, or assisted, by a processor. Embodiments of computer-readable media may comprise, but are not limited to, ail electronic, optical, magnetic, or other storage or transmission device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. Also, various other devices may include computer-readable media, such as a router, private or public network, or other transmission device. The processor, and the processing, described may be in one or more structures, and may be dispersed through one or more structures. The processor may comprise code for carrying out one or more of the methods (or parts of methods) described herein.

Some embodiments may be computationally-intensive. The problem of ensuring adequate performance of a computationally-intensive application is conventionally addressed in a number of ways. The simplest approach is to buy more powerful servers. Other approaches for addressing these needs include implementing a grid computing architecture.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed:

1. A system for surgical simulation, comprising:
a subject body having an outer surface and defining at least one cavity;
a capture mechanism configured to receive an instrument, the capture mechanism mounted to a robotic positioning assembly within the cavity;
a sensor configured to determine the position of at least one instrument; and
a processor configured to receive data from the sensor indicating the position of the at least one instrument relative to the cavity in the subject body and provide a command to the robotic positioning assembly to adjust the position of the capture mechanism.

2. The system set forth in claim 1, wherein the robotic positioning assembly is configured to allow at least two degrees of freedom in adjusting the position of the capture mechanism.

3. The system set forth in claim 1, wherein the robotic positioning assembly is configured to allow three degrees of freedom in adjusting the position of the capture mechanism.

4. The system set forth in claim 1, wherein the subject body comprises a human mannequin.

5. The system set forth in claim 1, wherein the processor is configured to adjust the position of the capture mechanism so that when the instrument approaches the outer surface of the subject body at a border of the cavity, the capture mechanism is positioned to capture the instrument once the instrument passes the outer surface of the subject body.

6. The system set forth in claim 5, wherein the subject body comprises a covering positioned at the outer surface, the covering piercable by the instrument.

7. The system set forth in claim 1, further comprising an actuator in communication with the processor,
wherein the processor is further configured to provide a haptic signal to the actuator to generate haptic feedback once the instrument is engaged by the capture mechanism.

8. The system set forth in claim 7, wherein the haptic feedback is generated via at least one of the instrument, the capture mechanism, or a wearable peripheral device in response to the haptic signal provided by the processor.

9. The system set forth in claim 1, further comprising a display device,
wherein the processor is further configured to present an overlay via the display device, the overlay configured to add one or more visual features to the surgical simulation.

10. The system set forth in claim 9, wherein the visual feature simulates at least one of an anatomical feature of the subject body, a condition of the subject body, and a instrument appearance.

11. A method of operating a surgical simulation system, the method comprising:
accessing position data from a sensor, the data indicating the position of an instrument relative to a surgical simulation system comprising a subject body;
accessing location data from a capture mechanism, the location data indicating a position of the capture mechanism in a cavity of the subject body; and
sending signals to a robotic positioning assembly to adjust the position of the capture mechanism so that the capture mechanism is positioned at or substantially at a simulated point of encounter with the subject body.

12. The method set forth in claim 11, further comprising adjusting the position of the capture mechanism in response to the signals by moving the capture mechanism within the cavity.

13. The method set forth in claim 11, further comprising adjusting the position of the capture mechanism by rotating the capture mechanism about at least one axis.

14. The method set forth in claim 11, further comprising:
engaging the capture mechanism and the instrument and providing haptic feedback via at least one of the instrument and the capture mechanism.

15. The method set forth in claim 11, further comprising:
providing output to generate at least one visual overlay in a field of view of a user of the surgical simulation system.

16. The method set forth in claim 15, wherein the visual overlay depicts at least one of an anatomical feature of a simulated patient, an appearance a surgical tool, or a simulated medical condition of the simulated patient.

17. An apparatus comprising:
a capture mechanism configured to receive an instrument, the capture mechanism mounted to a robotic positioning assembly configured for positioning the capture mechanism within a cavity of a mannequin for a surgical simulation system.

18. The apparatus set forth in claim 17, wherein the robotic positioning assembly is configured to allow at least two degrees of freedom in adjusting the position of the capture mechanism.

19. A computer readable medium tangibly embodying program instructions which, when executed by a processor, cause one or more processors to perform steps comprising:
determining the position of a surgical tool relative to a simulated patient;
determining the location of a tool capture mechanism relative to the simulated patient; and
sending signals to a robotic positioning assembly to position the tool capture mechanism at or substantially at the point at which the surgical tool will encounter the simulated patient.

20. The computer readable medium set forth in claim 19, wherein the program instructions cause the one or more processors to perform steps further comprising:
sending signals to generate haptic feedback once the tool capture mechanism encounters the simulated patient.
